(19) United States
(12) Patent Application Publication
(10) Pub. No.: US 2015/0219527 A1
(43) Pub. Date: Aug. 6, 2015

(54) METHOD AND ARRANGEMENT OF MEASURING A MECHANICAL BEARING OSCILLATION

(71) Applicant: AKTIEBOLAGET SKF, Göteborg (SE)

(72) Inventors: Joseph Erskine, Falkirk (GB); Keith Hamilton, Dunfermline (GB); Gerard McGoogan, Philipstoun West Lothian (GB); Tim Smith, Aberdour (GB); Allan Thomson, Lanark (GB); Andreas Clemens Van Der Ham, Utrecht (NL); Sebastian Ziegler, Schweinfurt (DE)

(21) Appl. No.: 14/395,510

(22) PCT Filed: Apr. 17, 2013
(86) PCT No.: PCT/EP2013/057995

§ 371 Date: Oct. 20, 2014

Related U.S. Application Data
(60) Provisional application No. 61/637,503, filed on Apr. 24, 2012.

(51) Int. Cl. G01M 13/04

(52) U.S. Cl. CPC G01M 13/045

(57) ABSTRACT

An arrangement and a method of measuring a mechanical bearing oscillation within a bearing, the bearing supporting a rotating shaft which is coupled to an inner ring of the bearing, the arrangement comprising: a bolt arranged in a force fit with an outer ring of the bearing in order to excite, by the bearing oscillation, a bolt oscillation; a sensor mechanically coupled to the bolt for registering the bolt oscillation, the bolt oscillation being indicative of the bearing oscillation.

### CROSS REFERENCE TO RELATED APPLICATIONS

This is a National Stage application claiming the benefit of International Application Number PCT/EP2013/057995 filed on 17 Apr. 2013 (17.04.2013), which claims the benefit of U.S. Provisional Patent Application No. 61/637,503 filed on 24 Apr. 2012, both of which are incorporated herein by reference in their entireties.

### FIELD OF THE INVENTION

Embodiments relate to a method and to an arrangement for measuring a mechanical bearing oscillation which in particular occurs during rotation of a wheel, such as a wheel of a bogie or carrier of a train.

### BACKGROUND

A mechanical bearing may support a rotation shaft to which a wheel is attached which may, for example, roll along and propagate along a railway. It may be desired to monitor the condition of the bearing during operation. Thereby, in condition monitoring it may be desired to measure vibrations or oscillations which originate from, for example, a rolling element bearing, for example, a bearing having rolling elements which are shaped as portions of cones, cylinders or spheres. Conventionally, a vibration sensor may be attached close to a vibration source by adhesive bonding or by a force fit to ensure a good transfer of the vibration between the target and the sensor surface.

Cast iron may be typically used for parts with complex geometries and high production volumes (such as motor blocks for combustion engines). As cast iron is resistant to oxidation, it is very popular and used frequently. However, cast iron structures have a relatively high vibration damping property due to carbon crystal(s) within the microstructure. Railway wheel end caps are typically manufactured from cast iron. However, the vibration damping or dampening property of cast iron, in particular, when used as a railway wheel end-cap, is unfavorable. In particular, the vibration dampening property dampens amplitudes of vibrations of the bearing before reaching a vibration sensor. Thus, the vibration sensor, in a conventional system, receives only relatively strongly decreased signal amplitudes due to the dampening of the oscillation via a transfer path involving the cast iron structure.

In these situations, conventionally, sensors with relatively high gain and expensive and complicated signal processing circuitry have been used in order to measure the bearing oscillation and acquire a corresponding measurement signal.

There is a need for an arrangement and a method for measuring a mechanical bearing oscillation which can reduce at least some of the above mentioned problems. In particular, there is a need for an arrangement and a method for measuring a mechanical bearing oscillation in situations, where materials or structures are present which have relatively high damping properties on mechanical oscillations or vibrations, in particular in the ultrasound frequency range.

### SUMMARY OF THE INVENTION

The need is solved by the independent claims which are directed to a method and an arrangement, respectively, of measuring a mechanical bearing oscillation. The dependent claims specify particular embodiments of the method and/or the arrangement.

It should be understood that features which are, individually, or in any combination, disclosed, described, mentioned or provided for a method of measuring a mechanical bearing oscillation are also applicable or can be provided for an arrangement of measuring a mechanical bearing oscillation according to an embodiment of the present invention, and vice versa.

According to a first aspect it is provided an embodiment for a method for measuring a mechanical bearing oscillation within a bearing is provided, wherein the bearing supports a rotating shaft which is coupled to an inner ring of the bearing. Thereby, the method comprises exciting, by the bearing oscillation, a bolt oscillation of a bolt arranged in a force fit with an outer ring of the bearing, in order to achieve a mechanical coupling for transferring the bearing oscillation to the bolt. Further, the method comprises registering the bolt oscillation using a sensor mechanically coupled to the bolt, the bolt oscillation being indicative of the bearing oscillation.

The outer ring may be fixed during operation in the sense that the outer ring is not rotating but is attached to a bogie of the vehicle having the shaft as a rotation axis to which wheels are attached. In particular, the inner ring may rotate with the shaft and thereby rotates relative to the outer ring. Between the outer ring and the inner ring the rolling elements may create the bearing oscillation. The bolt may be tightened to the outer ring of the bearing such that the bearing oscillation is transferred as a bolt oscillation to the bolt. In turn, the bolt oscillation may be registered by the sensor which may (directly) be attached to the bolt or which may be indirectly coupled to the bolt, by one or more intermediate structures. In particular, the sensor may not rotate during operation but may be at rest relative to the outer ring of the bearing and also relative to the saddle adapter. Thereby, the sensor does not need to be in close proximity to the bearing but may be arranged at a location which is more easily accessible for maintenance purposes. Further, the bolt may effectively transfer the bearing oscillation towards the sensor, in order to enable an accurate measurement of the bearing oscillation.

The bearing (radially outwards from the inner ring) comprises the outer ring which represents a fixed element (i.e. non-rotating element) during rotation of the shaft. In-between the inner ring and the outer ring plural rolling elements may be arranged which role during rotation of the shaft and which may cause excitation of the bearing oscillation, in particular in an ultrasound frequency range, such as a frequency range between 100 kHz and 500 kHz. The outer ring of the bearing may be fixed at a saddle adapter of a bogie or carriage of a train and the saddle adapter may in turn be fixed at a bogie of the carriage of the train. Axially (i.e. in the direction of the axis of the shaft) inwards from the bearing a wheel (in particular two wheels on the same shaft) may be fixedly attached or connected to the shaft such that the wheels rotate synchronously with the shaft. Also the inner ring of the bearing rotates synchronously with the rotation of the shaft. The bearing oscillation may be due to the rolling of the rolling elements between the inner ring and the outer ring of the bearing. The bearing oscillation may involve an oscillation of the outer ring, an oscillation of the rolling elements and/or an oscillation of the inner ring. The bearing oscillation may be transferred, due to the coupling between the bolt and the shaft, to the bolt as a bolt oscillation. The transfer of the bearing oscillation via the bolt to the sensor may be achieved by a respective strong and tight coupling between the outer ring and the bolt and between the bolt and the sensor and by using appropriate materials for the outer ring, the bolt and any intermediate structure between the bolt and the sensor.

In particular, the bolt may be used to bridge a vibration or the oscillation from a steel part via a cast iron structure to the sensor unit. Thereby, the necessary surface for transmitting the vibration should preferably be at least a factor 0.5 of the inner screw diameter. The force between the first surfaces should preferably be at least 400 N/mm² multiplied with the surface of the bolt inner diameter. The sensor unit may thereby be arranged outside of the bearing unit which may allow an easy replacement of the sensor unit. In particular, the sensor unit may be retrofitted without modification.

Via the bolt so-called acoustic emission being a mechanical oscillation in the frequency range between 100 kHz and 500 kHz may be transferred from the source of the oscillation, i.e. the bearing, to the sensor. The sensor may in particular comprise a piezo-electric sensor or a MEM-sensor (MEM=Micro-Electro-Mechanical). In particular, a first side of the sensor may be mechanically coupled to the bolt, while a second side of the sensor may not attached to the bolt but may be free to oscillate in response to the first side being excited by the bolt oscillation. In particular, the first side may sense the bolt oscillation and a distance between the first side and the second side may change due to the bolt oscillation which in turn may, due to the piezoelectric effect, generate a voltage based on the changing distance. The voltage may change in accordance to or synchronously with the change of the distance, i.e. thereby reflecting the amplitude and the frequency of the bolt oscillation. Further, the bolt oscillation may essentially have a same frequency (or frequency range) as the bearing oscillation and may have an amplitude which may in particular linearly dependent on an amplitude of the bearing oscillation. Although the amplitude of the bolt oscillation may be smaller than the amplitude of the bearing oscillation, there may be a relatively low damping across the oscillation transfer path between the bearing and the sensor, in particular due to the bolt which may effectively transfer the shaft oscillation towards the sensor.

According to an embodiment the bolt may extend with a threading portion of the bolt through a saddle adapter fixed to the outer ring of the bearing, the saddle adapter comprising or being made of cast iron. In particular, the saddle adapter may have a strong damping effect on mechanical oscillations occurring at the bearing and may thus transfer these oscillations very purely. Thus, placing the sensor directly at the saddle adapter would result in the sensor receiving only a very weak signal of the bearing oscillation, in particular, if the bearing oscillation comprises oscillation in a frequency range between 100 kHz to 500 kHz. However, using the bolt being force fit to the outer ring of the bearing enables for effectively transferring the bearing oscillation to the sensor.

According to an embodiment the saddle adapter may be fixed at a bogie of a vehicle, in particular a railway vehicle. Thereby, a conventional railway vehicle, such as a railway truck or a railway carriage may be retrofitted with the arrangement of measuring the mechanical bearing oscillation and also the method of measuring the mechanical bearing oscillation according to an embodiment of the present invention may be performed starting with a conventional railway vehicle and adapting it to comprise the bolt being in mechanical coupling with the outer ring of the bearing, wherein the sensor is attached to the bolt.

According to an embodiment an oscillation transfer path may be formed extending from the bearing via the bolt to the sensor, wherein the transfer path is adapted to transfer the bearing oscillation such that an amplitude of the bolt oscillation is between 0.3 and 0.9, in particular between 0.5 and 0.7, times an amplitude of the bearing oscillation. Thereby, an accurate measurement by the sensor may be enabled and complicated an expensive processing circuitry may be dispensed with.

Registering the bolt oscillation may further comprise electronic processing of primary sensor measurement signals. The processing of the primary sensor measurement signals may involve amplification, filtering, and so on, in particular to filter out disturbing signals. For further condition monitoring a temperature sensor may be arranged, in particular close to the bolt or close to the vibration sensor. By providing the oscillation transfer path having a low damping effect it may be enabled to accurately measure a bearing oscillation using the sensor which is not directly in contact with the bearing but which is remote from the bearing and which is more easily accessible for maintenance, in particular replacement, service. The bolt may for example be a conventional bolt.

According to an embodiment the bolt may be tightened with a sufficient pressure of between 100 N/mm̂2 to 1500 N/mm̂2, in particular between 200 N/mm̂2 to 1000 N/mm̂2, further in particular between 400 N/mm̂2 to 800 N/mm̂2, further in particular between 500 N/mm̂2 to 700 N/mm̂2, to the outer ring of the bearing, in order to achieve a strong mechanical coupling between the bolt and the shaft for effectively transferring the shaft rotation of shaft oscillation to the bolt oscillation. The pressure with which the bolt is tightened to the shaft should be below the limit pressure which is set for the bolt from the manufacturer.

According to an embodiment the bolt may comprise a contact surface in contact with the outer ring of the bearing which corresponds to (or is at least substantially equal to) between 0.3 and 1.0, in particular between 0.3 and 0.7, times a cross-sectional surface taken at the outer threading portion of the bolt. The contact surface may comprise a portion of an end face (particularly axial end face) of the bolt in contact with the outer ring of the bearing. The bolt end face may press with a high force to the outer ring of the bearing, in order to achieve a strong mechanical coupling.

Further, another contact surface of the bolt may be present for contacting an intermediate structure between the bolt and the sensor in the case the sensor is not directly attached to the bolt, for example at the head of the bolt. In particular, when the intermediate structure is a metal sheet, or a washer, the other contact surface may be formed by a ring-shaped face of the head of the bolt which may press towards the sheet metal with a high pressure, as specified above, thereby generating a sufficient force for transferring the oscillation from the bolt to the intermediate structure, in particular the metal sheet.

According to an embodiment the method may further comprise coupling a metal sheet, in particular embodied as a washer, with the bolt due to tightening the bolt towards the outer ring of the bearing, wherein the sensor is attached onto the metal sheet using a glue, the saddle adaptor being in particular located between the metal sheet and the outer ring of the bearing. The metal sheet may be pressed to the other contact surface of the bolt with a sufficiently high force, such as to effectively transfer the bolt oscillation to a metal sheet oscillation which may then be sensed by the sensor attached to the metal sheet. In particular, the metal sheet may have a sufficiently large area, in order to enable placement of the sensor onto the metal sheet.

Thereby, the sensor may in particular have a diameter between 4 and 8 mm and the sensor may have a height between 2 and 4 mm. Other sensor sizes may apply. The glue may be in particular adapted for effective transfer of the oscillation. Also a conventional washer may be utilized provided that the washer has a sufficiently large area for placement of the sensor. In particular, further circuitry such as a circuit board may be attached or placed at the metal sheet, e.g. circuitry for processing the sensor signal and/or for transmitting the sensor signals, in particular wirelessly, to a data acquisition equipment and further processing equipment which may be located within the carriage or within the train.

According to an embodiment the sheet metal may comprise or is made of steel, in particular cold rolled sheet of soft steel according to DIN EN 10130, warm rolled sheet metal from allow or non-allow steel according to DIN EN 10051, warm rolled sheet metal of construction steel according to DIN EN 10025, or stainless steel according to DIN EN 10088, wherein DIN means “Deutsches Institut für Normung e.V.” (english: German Institute for Standardization). Thereby, good oscillation transfer properties may be provided, in order to enable measurement of the oscillation using the sensor located remote from the bearing.

According to an embodiment the sensor may be attached to the bolt, in particular to a head of the bolt, using glue. Thereby, a simple procedure for fixing the sensor at the bolt and providing a strong mechanical coupling may be achieved.

According to an embodiment the glue (which may be used to attach the sensor to the metal sheet or to the bolt) may comprise hard metal particles, in particular comprising at least one of or a combination of the group of tungsten, W, tungsten carbide, W2C, WC, titanium nitride, TiN, titanium carbide, TiC, titanium carbide-nitride, Ti(C)N, titanium aluminum nitride, TiAlN, tantalum carbide TaC, cobalt, Co, and molybdenum, Mo, mixed with epoxy resin (which may in particular have been cross-linked). Due to the hard metal particles an effective transfer of the oscillation from the surface portions which are attached to each other may be achieved.

According to an embodiment the bolt may comprise or may be made of steel, in particular comprising Chromium (Cr) and/or Molybdenum (Mo) and/or Vanadium (V) and/or Nickel (Ni) and/or Niobium (Nb), in particular according to DIN 17111, DIN EN 10263-1, DIN EN 10087, DIN EN 10016-1, DIN EN 10084, DIN EN 10269 or DIN EN 10083. Thereby, these materials may provide an effective transfer of the oscillation, involving low damping.

According to an embodiment the outer ring (and/or the inner ring) of the bearing may comprise or may be made of steel, in particular comprising Cr of at least 1.5 wt % (wt %=weight percent), in particular comprising Carbon (C) between 0.1 wt % and 2 wt %, in particular comprising Cr and/or Mo, in particular according to ISO 683-17:1999, ISO 683-17:1999, EN 10088-1:1995 wherein ISO means “International Organization for Standardization”. That is to say, x wt % of a component in an alloy means that the component makes up x% of the alloy's mass or weight. Thereby, the outer ring of the bearing may withstand stress during the operation and may further effectively transfer an oscillation of the bearing towards the bolt. In particular, the inner ring and the shaft may be welded together or may comprise a press fit.

According to an embodiment the bearing oscillation transferred to the bolt as the bolt oscillation may have a frequency between 100 kHz and 500 kHz. This frequency range may also refer to as ultrasound range or acoustic emission range. The bearing condition may further be characterized by oscillation within a lower frequency range such as a range between 0 and 10 kHz. However, in this low frequency mechanical oscillation range the dampening effect of cast iron may be less pronounced such that a corresponding low frequency vibration sensor may possibly be placed onto the cast iron structure itself, for example at the end cap or the saddle adaptors. In other embodiments also the low frequency vibration sensor may be placed onto the metal sheet, depending on the particular application.

According to a further aspect it is provided an arrangement of measuring a mechanical bearing oscillation within a bearing is provided, wherein the bearing supports a rotating shaft which is coupled to an inner ring of the bearing. Thereby, the arrangement comprises a bolt which is arranged in a force fit with an outer ring of the bearing in order to excite, by the bearing oscillation, a bolt oscillation. Further, the arrangement comprises a sensor mechanically coupled to the bolt for registering the bolt oscillation, the bolt oscillation being indicative of the bearing oscillation. The arrangement may be adapted to perform a method of measuring a mechanical bearing oscillation according to an embodiment of the present invention.

### BRIEF DESCRIPTION OF THE DRAWINGS

FIG. 1 schematically illustrates a cross-sectional view of a portion of a railway truck or driving section comprising an arrangement of measuring a mechanical bearing oscillation according to an embodiment of the present invention which may be used in a method of measuring a mechanical bearing oscillation according to an embodiment of the present invention;

FIG. 2 schematically illustrates a cross-sectional view of a portion of a driving section comprising an arrangement of measuring a mechanical bearing oscillation according to another embodiment of the present invention which may be used in a method of measuring a mechanical bearing oscillation according to another embodiment of the present invention; and

FIG. 3 illustrates a portion of a railway truck comprising the arrangement illustrated in FIG. 1 or 2.

### DETAILED DESCRIPTION OF THE EMBODIMENTS

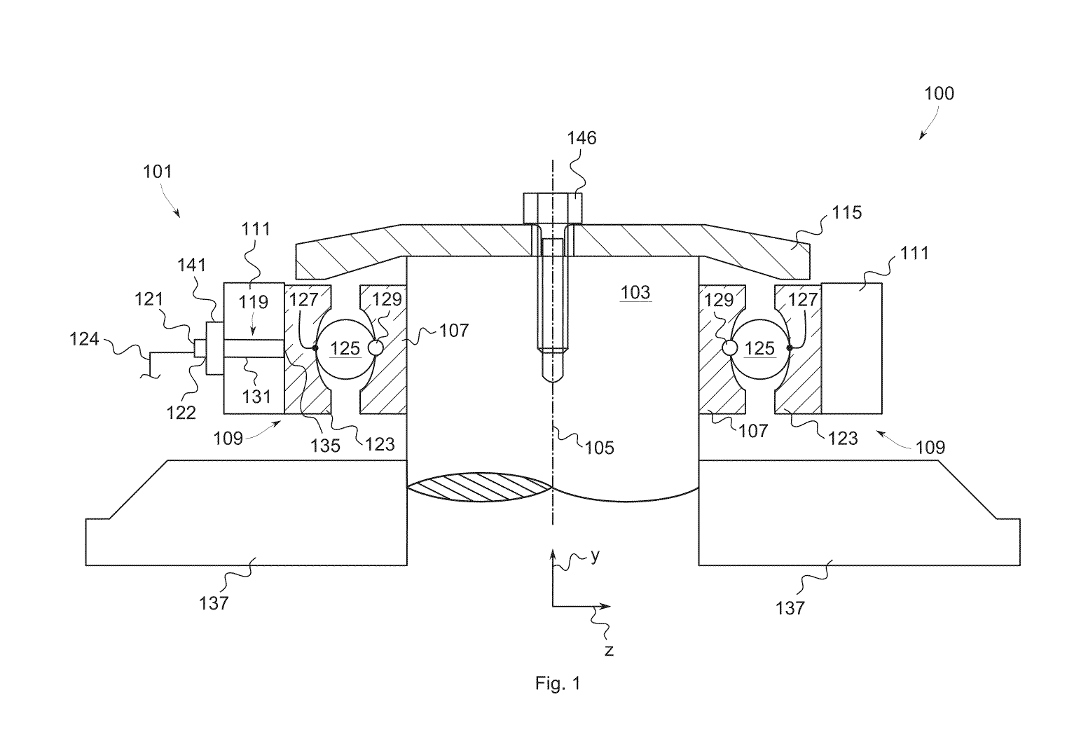

FIG. 1 schematically illustrates a portion 100 of a drive train of a railway vehicle which comprises an arrangement 101 for measuring a mechanical bearing oscillation within a bearing 109. The arrangement 101 comprises a bolt 119 comprising an outer threading portion 131 which is in mechanical contact with an outer ring 123 of the bearing 109, in order to transfer a bearing oscillation to a sensor 121 which is attached to the head 141 of the bolt 119 using an adhesive 122, in particular comprising hard metal particles mixed with an epoxy resin. The sensor 121 may for example be a piezoelectric sensor which generates primary measurement signals, for example voltage signals, which reflect amplitude and/or frequency of the bearing oscillation of the bearing 109. The primary measurement data may be transferred via a cable 124 or wirelessly to further processing equipment within the vehicle. Advantageously, the sensor 121 is at rest relative to the outer ring 123 and relative to the saddle adapter 111.

The bolt 119 may provide a vibration bridge between the outer ring 123 and the sensor 121. Thereby, the threading portion 131 of the bolt may act as a steel insert touching the bearing for exciting a bolt oscillation originating from the bearing oscillation. By the steel insert (embodied as the bolt 119) a data quality of the measurement data of the sensor 121 may be improved. In particular, the bolt 119 tightly contacting the outer ring 123 may provide a good path of vibrations from the source (i.e. the bearing) to the sensor 121. A bogie (not illustrated) holds the saddle adapter 111. An end cap fixing screw 146 fixes the end cap 115 to the shaft 103.

The shaft 103 is adapted for rotating around a rotation axis 105 which corresponds to y-axis. A z-axis is perpendicular to the y-axis and corresponds to a radial direction, while the y-axis (105) is also referred to as the axial direction. The shaft 103 is coupled to the inner ring 107 of a bearing 109, wherein the bearing 109 supports the shaft 103 relative to a saddle adapter 111 and the not illustrated bogie 113 which are both fixed during operation, while the shaft rotates together with the inner ring 107, the end cap 115 and the screw 146. The bearing 109 comprises an outer ring 123 which is arranged radially outwards from the inner ring 107 and further a plurality of rolling elements 125 which may for example have a cone or cylinder type shape. Between contact surfaces of the inner ring 107 and the rolling element as well as between contact surfaces between the outer ring 123 and the rolling elements 125 a not illustrated lubricant is arranged for decreasing a friction force during operation. At contact areas or contact points 127, 129 between the rolling element 125 and the outer ring 123 or between the rolling element 125 and the inner ring 129, respectively, a vibration is generated during operation, i.e. while the shaft 103 is rotating.

An arrangement 101 according to an embodiment of the present invention is adapted for measuring an oscillation originating from the contact points or contact regions 127, 129, which oscillations may indicate a condition of the bearing 109. Therefore, the arrangement 101 of measuring a mechanical bearing oscillation comprises the bolt 119 having an outer threading portion 131 screwed through the saddle adaptor 111 towards the outer ring 123, to which a force fit is established, in order to achieve a mechanical coupling for transferring the bearing oscillation to excite a bolt oscillation. In particular, the bearing oscillation is generated due to the oscillations at the contact regions 127, 129. The bolt 119 transfers the bolt oscillation to the sensor 121, such as a piezo-electric sensor, that is glued onto the head 141 of the bolt 119, thereby causing the bolt oscillation to be transferred to the sensor 121. For effectively transferring the bearing oscillation to the bolt 119 the bolt 119 comprises a contact surface 135 at the end face of the screw such that this end surface 135 firmly presses towards an outer surface of the outer ring 123 of the bearing 109.

The shaft 103 may extend in the axial direction (i.e. along the y-direction) and on another not illustrated portion of the shaft a further bearing may be provided for supporting the shaft at the other end. Fixed to the shaft is a wheel 137 which may contact a not illustrated railway during operation. On the other end of the shaft a further wheel may be arranged (which is not illustrated in FIG. 1).

The saddle adaptor 111 is manufactured from cast iron which has a pretty high damping effect on oscillations in the ultrasound region. However the bolt (which has a strong mechanical coupling to the outer ring 123 as well as to the sensor 121) has low damping property and thus effectively transfers the bearing oscillation to the sensor 121. In particular, the measuring arrangement 101 may be retrofitted in existing railway trucks. Advantageously, the sensor 121 may be easily accessible by a technician.

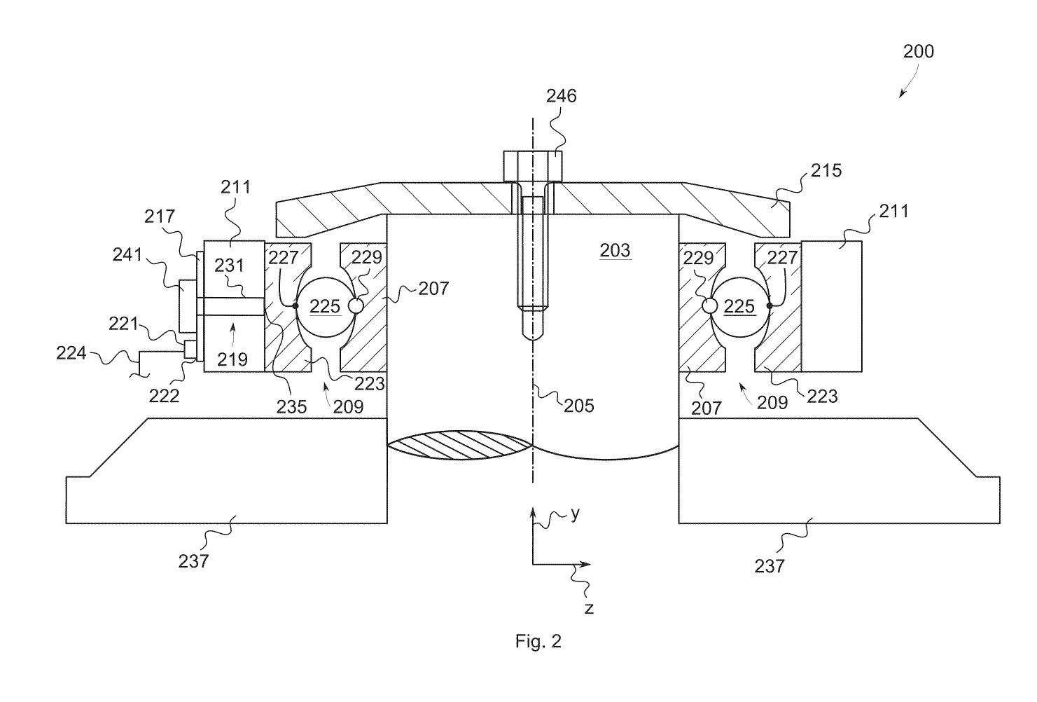

FIG. 2 illustrates schematically a cross-sectional view of a portion 200 of a drive train comprising an arrangement 201 of measuring a mechanical bearing oscillation according to another embodiment of the present invention. It should be noted that elements similar in structure and/or function in FIGS. 1 and 2 are labeled with the same reference numbers differing only in the first digit.

The arrangement 201 of measuring a mechanical bearing oscillation of a bearing 209 illustrated in FIG. 2 comprises a bolt 219 and a sensor 221 as the arrangement 101 illustrated in FIG. 1. However, differing from the embodiment illustrated in FIG. 1, the sensor 221 is attached to a sheet metal 217 which is hold by the bolt 219 and coupled to the bolt 219 (e.g. by force fit) for transferring the oscillation. The sensor 221 is attached onto the sheet metal 217 (e.g. using glue 222). The description of other elements illustrated in FIG. 2 may be taken from the description relating to FIG. 1. The sheet metal 217 may also be embodied as a washer. The sheet metal 217 may act as a rail sensor mounting plate, wherein the sheet metal 217 (and/or the saddle adaptor 211) may be in particular machined such that a good mechanical coupling is achieved between the bolt 219 (in particular a face of a head 141 of the bolt 119) and the outer ring 223 and to achieve a good mechanical coupling between the sheet metal 217 and the sensor 221 which may be glued onto the sheet metal 217 using glue 222 (which may comprise e.g. hard metal particles mixed with a resin material).

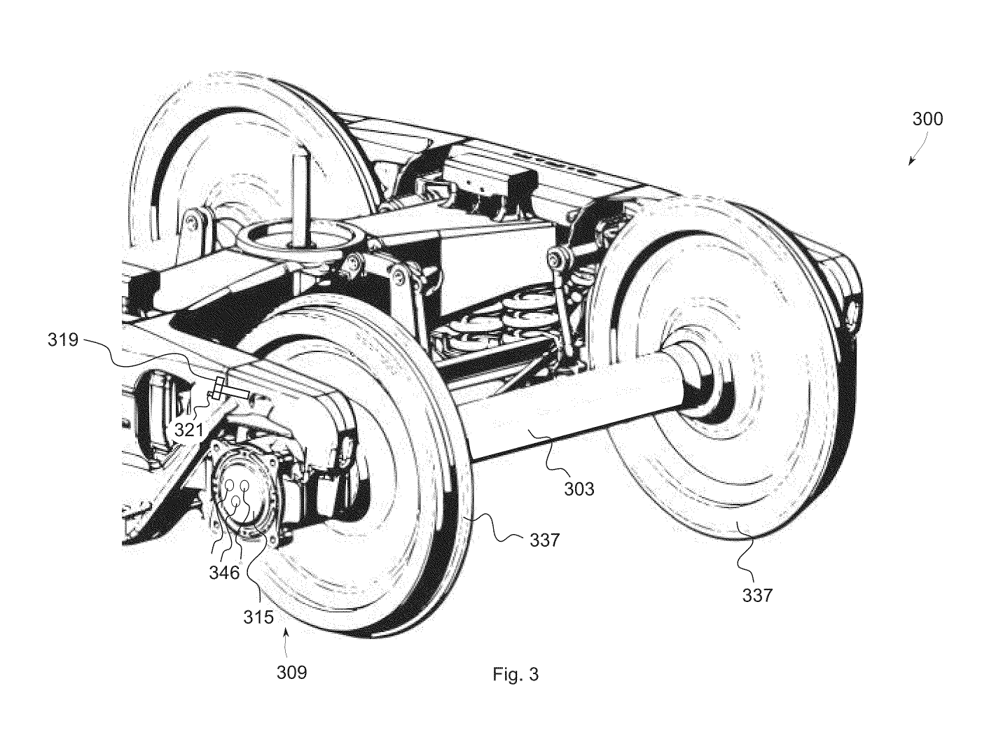

FIG. 3 illustrates a portion of a railway truck 300 in which an arrangement 101 or 201 of measuring a bearing oscillation may be integrated and in which a method of measuring a bearing oscillation according to an embodiment of the present invention may be performed.

Two wheels 337 are fixed at the shaft 303, wherein the shaft 203 is supported by a bearing 309 which is attached to a saddle adapter 311 which is in turn attached to a bogie 313. Also illustrated in FIG. 3 is the end cap 315 which is made from cast iron. The bearing 309 is partially occluded by the end cap 315 but the bearing comprises an outer ring which transfers the bearing oscillation to the bolt 319 onto which a sensor 321 is glued. FIG. 3 further illustrates three cap fixing screws 346 hold the end cap 315. Details of the coupling between the bolt 319 on one hand and the sensor 321 and the outer ring of the bearing on the other hand can be taken from FIG. 1 or 2.

According to an embodiment the bolt may comprise or may be made of steel, in particular comprising Cr and/or Mo and/or V and/or Ni and/or Nb, in particular according to DIN 17111, DIN EN 10263-1, DIN EN 10087, DIN EN 10016-1, DIN EN 10084, DIN EN 10269 or DIN EN 10083. Thereby, these materials may provide an effective transfer of the oscillation, involving low damping.

The sheet metal 217 may be cold rolled or warm rolled steel sheet, e.g. according the regulations/rules: DIN EN 10130; DIN EN 10051; DIN EN 10025; DIN EN 10088.

### REFERENCE SIGNS

100 portion of drive train
101 arrangement of measuring a bearing oscillation
103 shaft
105 shaft rotation axis
107 inner ring of bearing
109 bearing
111 saddle adapter
113 bogie
115 end cap
217 sheet metal
119 bolt
121 sensor
123 outer ring of bearing
125 rolling element
127, 129 contact regions of the bearing
131 outer threading portion of the bolt
135 end face of the threading portion of the bolt
137 railway wheel
139 railway
141 head of the bolt
146 end cap fixing screw
2xx, 3xx as 1xx

1. A method for measuring a mechanical bearing oscillation within a bearing, the bearing supporting a rotating shaft which is coupled to an inner ring of the bearing, the method comprising steps of:
exciting, by the bearing oscillation, a bolt oscillation of a bolt arranged in a force fit with an outer ring of the bearing in order to achieve a mechanical coupling for transferring the bearing oscillation to the bolt; and
registering the bolt oscillation using a sensor mechanically coupled to the bolt, the bolt oscillation being indicative of the bearing oscillation.

2. The method according to claim 1, wherein the bolt extends with a threading portion (131) of the bolt through a saddle adaptor fixed to the outer ring of the bearing, the saddle adaptor comprising or being made of cast iron.

3. The method according to claim 1, wherein the saddle adaptor is fixed at a bogie of a vehicle.

4. The method according to claim 1, wherein an oscillation transfer path is formed extending from the bearing via the bolt to the sensor, wherein the transfer path is adapted to transfer the bearing oscillation such that an amplitude of the bolt oscillation is between 0.3 and 0.9 times an amplitude of the bearing oscillation.

5. The method according to claim 4, wherein the bolt is tightened with a pressure of between 100 N/mm̂2 to 1500 N/mm̂2 to the outer ring of the bearing, in order to achieve a strong mechanical coupling between the outer ring and the bolt.

6. The method according to claim 1, wherein the bolt comprises a contact surface in contact with the outer ring of the bearing, the contact surface corresponding to between 0.3 and 1.0 times a cross-sectional surface taken at the outer threading portion of the bolt, the contact surface having in particular an area of between 5 mm̂2 and 100 mm̂2.

7. The method according to claim 1, further comprising:
coupling a metal sheet (117), in particular embodied as a washer, with the bolt, due to tightening the bolt to the outer ring, wherein the sensor is attached onto the metal sheet using a glue, and the saddle adaptor is located between the metal sheet and the outer ring.

8. The method according to claim 7, wherein the sheet metal comprises one of steel, cold rolled sheet of soft steel according to DIN EN 10130, warm rolled sheet metal from alloy or non-alloy steel according to DIN EN 10051, warm rolled sheet metal of construction steel according to DIN EN 10025, or stainless steel according to DIN EN 10088.

9. The method according to claim 1, wherein the sensor is attached to the bolt using glue.

10. The method according to claim 1, wherein the glue comprises at least one of hard metal particles, tungsten, W, tungsten carbide, W2C, WC, titanium nitride, TiN, titanium carbide, TiC, titanium carbide-nitride, Ti(C)N, titanium aluminum nitride, TiAlN, tantalum carbide TaC, cobalt, Co, and molybdenum, Mo, mixed with epoxy resin.

11. The method according to claim 1, wherein the bolt comprises at least one of steel, Cr, Mo, V, Ni, and Nb, according to at least one of DIN 17111, DIN EN 10263-1, DIN EN 10087, DIN EN 10016-1, DIN EN 10084, DIN EN 10269 and DIN EN 10083.

12. The method according to claim 1, wherein the outer ring of the bearing comprises steel, having Cr of at least 1.5 wt %, C between 0.1 wt % and 2 wt %, Mo, according to ISO 683-17:1999, ISO 683-17:1999, EN 10088-1:1995.

13. The method according to claim 1, wherein the bearing oscillation transferred to the bolt as the bolt oscillation has a frequency between 100 kHz and 500 kHz.

14. An arrangement for measuring a mechanical bearing oscillation within a bearing, the bearing supporting a rotating shaft which is coupled to an inner ring of the bearing, the arrangement comprising:
a bolt arranged in a force fit with an outer ring of the bearing in order to excite, by the bearing oscillation, a bolt oscillation; and
a sensor mechanically coupled to the bolt for registering the bolt oscillation, the bolt oscillation being indicative of the bearing oscillation.
